(19) United States
(12) Patent Application Publication
(10) Pub. No.: US 2004/0180622 A1
(43) Pub. Date: Sep. 16, 2004

(54) Coordinating multiple air-interface subsystems that serve a common host

(76) Inventor: Timothy Gordon Godfrey, Overland Park, KS (US)

Correspondence Address: DEMONT & BREYER, LLC, SUITE 250, 100 COMMONS WAY, HOLMDEL, NJ, 07733, US

(21) Appl. No.: 10/680,877

(22) Filed: Oct. 8, 2003

Related U.S. Application Data
(60) Provisional application No. 60/453,613, filed on Mar. 11, 2003.

(51) Int. Cl. H04B 7/00

(52) U.S. Cl. 455/41.2

(57) ABSTRACT

A technique for coordinating potentially-conflicting air-interface subsystems in the same station is disclosed. In accordance with the first illustrative embodiment of the present invention, a first air-interface subsystem that is compliant with a first protocol (e.g., IEEE 802.11, etc.) and a second air-interface subsystem that is compliant with a second protocol (e.g., Bluetooth, etc.) both have direct physical interfaces with the host that they serve. The two subsystems coordinate their operation via messages that are shuttled between them by the host. In accordance with the second illustrative embodiment, the first air-interface subsystem and the second air-interface subsystem both have a logical connection with the host that they serve, but only the first air-interface subsystem has a physical connection with the host. The second air-interface subsystem cannot exchange messages with the first air-interface subsystem directly but can only do so by routing them through the host.

### CROSS-REFERENCE TO RELATED APPLICATIONS

This application claims the benefit of:

1. U.S. provisional application Serial No. 60/453,613, filed Mar. 11, 2003, entitled “Inter-Radio Signaling With a Host Computer” (Attorney Docket: 680-058us), which is also incorporated by reference.

The following patent applications are incorporated by reference:

1. U.S. patent application Ser. No. 10/444,383, filed 23 May 2003, entitled “Multi-Protocol Interchip Interface” (Attorney Docket: 680-021us),

2. U.S. patent application Ser. No. 10/444,519, filed 23 May 2003, entitled “Coordination of Competing Protocols” (Attorney Docket: 680-030us),

3. U.S. patent application Ser. No. 10/___,___, entitled “Transmit Request Signaling Between Transceivers” (Attorney Docket: 680-062us), and

4. U.S. patent application Ser. No. 10/___,___, entitled “Advance Notification of Transmit Opportunities on a Shared-Communications Channel” (Attorney Docket: 680-063us).

### FIELD OF THE INVENTION

The present invention relates to telecommunications in general, and, more particularly, to wireless local area networks.

### BACKGROUND OF THE INVENTION

FIG. 1 depicts a schematic diagram of a portion of wireless local area network 100 in the prior art. Wireless local area network 100 comprises wireless stations 101-1 through 101-6, which communicate with each other via the same, shared-communications channel and by using one or more air-interface protocols (i.e., physical and logical standards for wireless communication).

Wireless stations 101-1, 101-2, and 101-4 communicate using one air-interface protocol (e.g., IEEE 802.11, etc.), wireless stations 101-5 and 101-6 communicate using a second air-interface protocol (e.g., Bluetooth, etc.), and wireless station 101-3 can communicate using both air-interface protocols.

Wireless station 101-3 uses the same, shared-communications channel for both its first air-interface communications and its second air-interface communications, and, therefore, it cannot use both air-interface protocols at the same time. For this reason, wireless station 101-3 must coordinate its first air-interface communications with its second air-interface communications.

There exist various techniques in the prior art for enabling a station to coordinate its various air-interface communications.

For example, FIG. 2 depicts a block diagram of the salient components of wireless station 101-3 in accordance with a first prior-art technique. As shown in FIG. 2, wireless station 101-3 comprises host 201, A/B switch 202, air-interface subsystem 203, air-interface subsystem 204, antenna switch 205, and antenna 206, interconnected as shown. Air-interface subsystem 203 communicates in accordance with the first air-interface protocol, and air-interface subsystem 204 communicates in accordance with the second air-interface protocol. Each air-interface subsystem comprises a “radio” and, therefore, can receive and transmit over the shared-communications channel using electromagnetic waves.

At any given instant, host 201 communicates with air-interface subsystem 203 or air-interface subsystem 204, but not both, by means of A/B switch 202. A/B switch 202 requires the user of wireless station 101-3 to select the air interface to be used and to manually toggle a two-position switch. In some cases, A/B switch is embedded in host 201 as a “soft switch” that the user toggles through an on-screen menu. Antenna switch 205 directs a signal to be transmitted to antenna 206 from either air-interface subsystem 203 or air-interface subsystem 204. The state of antenna switch 205 is coupled to the state of A/B switch 202.

The first technique is advantageous because it coordinates the use of the air-interface subsystems in an economical matter, but is disadvantageous, however, because the manual nature of the switching mechanism limits the rate at which the air-interface subsystems can be switched to the rate at which a human can switch them.

FIG. 3 depicts a block diagram of the salient components of wireless station 101-3 in accordance with a second prior-art technique. As shown in FIG. 3, wireless station 101-3 comprises host 301, tandem air-interface subsystem 302, and antenna 303, interconnected as shown. The second prior-art technique is characterized by a tandem air-interface subsystem, which is a fully-custom dual air-interface subsystem that is capable of functioning as both an first air-interface subsystem and a second air-interface subsystem on a moment-by-moment basis.

Tandem air-interface subsystem 302 is a single integrated circuit that communicates in accordance with the first air-interface protocol and with the second air-interface protocol. Host 301 maintains a logical, if not also physical, interface with the first air-interface protocol part of tandem air-interface subsystem 302 and a logical, if not also physical, interface with the second air-interface protocol part of tandem air-interface subsystem 302. The unified nature of tandem air-interface subsystem 302 inherently coordinates the use of the first air-interface protocol and the second air-interface protocol.

The second prior-art technique is advantageous because it coordinates the use of the air-interface subsystems and because it enables the host to switch between the two air interfaces at a very high rate.

The second prior-art technique is disadvantageous, however, because it requires a fully-custom development effort for each combination of air-interface subsystems, which is slow and expensive.

FIG. 4 depicts a block diagram of the salient components of wireless station 101-3 in accordance with a third prior-art technique. Wireless station 101-3 comprises host 401, air-interface subsystem 402, air-interface subsystem 403, antenna switch 404, antenna 405, and inter-subsystem interface 406, interconnected as shown. Air-interface subsystem 402 and air-interface subsystem 403 are interconnected by inter-subsystem interface 406. Inter-subsystem interface 406 comprises once or more signaling leads and carries signals in accordance with a standard protocol. Inter-subsystem interface 406 enables air-interface subsystem 402 and air-interface subsystem 403 to exchange messages to coordinate their use.

The third prior-art technique is advantageous because it coordinates the use of the air-interface subsystems, because it enables the host to switch between the two air interfaces at a very high rate, and because it is less expensive than the dual-air-interface solution. Furthermore, the third prior-art technique is advantageous because it enables the development of each air-interface subsystem to be performed independently of other air-interface subsystems.

The third prior-art technique is disadvantageous, however, because inter-subsystem interface 406 increases the cost of both air-interface subsystems.

Therefore, the need exists for a technique to coordinate multiple air-interface subsystems without some of the disadvantages associated with techniques in the prior art.

### SUMMARY OF THE INVENTION

The present invention is a technique for coordinating potentially-conflicting air-interface subsystems in the same station. In particular, the illustrative embodiments of the present invention coordinate the air-interface subsystems by having the host shuttle messages back and forth between the air-interface subsystems.

Some embodiments of the present invention are advantageous because they enable the host to switch between the two air interfaces at a very high rate, and because they are less expensive than the dual-air-interface solution. Furthermore, some embodiments of the present invention enable the development of each air-interface subsystem to be performed independently of other air-interface subsystems.

In accordance with the first illustrative embodiment of the present invention, a first air-interface subsystem that is compliant with a first protocol (e.g., IEEE 802.11, etc.) and a second air-interface subsystem that is compliant with a second protocol (e.g., Bluetooth, etc.) both have direct physical interfaces with the host that they serve. The two subsystems coordinate their operation via messages that are shuttled between them by the host.

In accordance with the second illustrative embodiment, the first air-interface subsystem and the second air-interface subsystem both have a logical connection with the host that they serve, but only the first air-interface subsystem has a physical connection with the host. The second air-interface subsystem does not have a physical connection with the host. Rather, the second air-interface subsystem has a physical connection with the first air-interface subsystem for passing messages to the host. The second air-interface subsystem cannot exchange messages with the first air-interface subsystem directly but can only do so by routing them through the host.

The host shuttles messages between the air-interface subsystems in hardware, software, or a combination of hardware and software. Although the illustrative embodiments comprise two air-interface subsystems, it will be clear to those skilled in the art, after reading this specification, how to make and use embodiments of the present invention that comprises any number of air-interface subsystems.

The illustrative embodiment comprises: receiving a first message at a host processor from a first processor via a wireline shared-communications channel, wherein the first processor performs channel-access control for a first radio, and wherein the first radio communicates via a wireless shared-communications channel on behalf of the host processor; determining with the host processor that the first message is directed to a second processor, wherein the second processor performs channel-access control for a second radio, and wherein the second radio communicates via the wireless shared-communications channel on behalf of the host processor; and forwarding the first message from the host processor to the second processor via the wireline shared-communications channel.

### BRIEF DESCRIPTION OF THE DRAWINGS

FIG. 1 depicts a schematic diagram of wireless local area network 100 in the prior art.

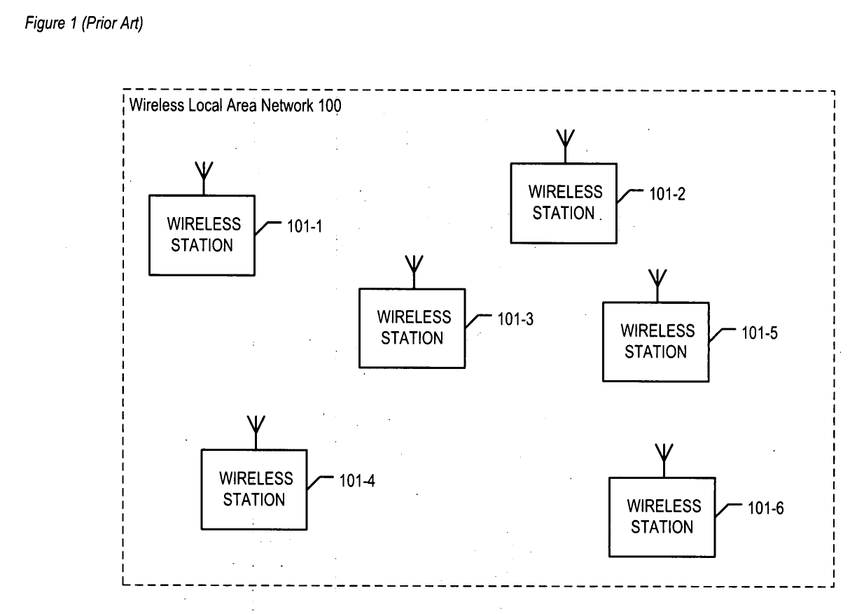

FIG. 2 depicts a block diagram of wireless station 101-3, in accordance with a first prior-art technique.

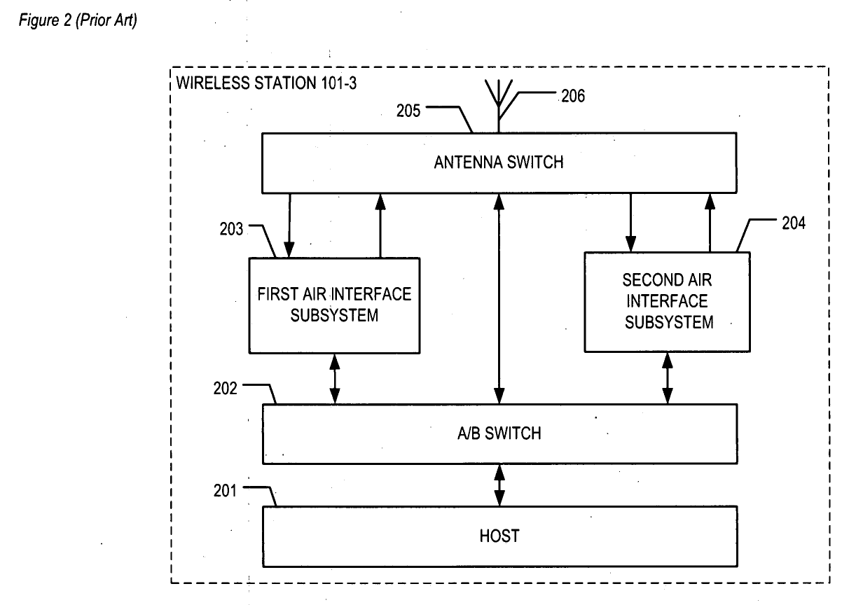

FIG. 3 depicts a block diagram of wireless station 101-3, in accordance with a second prior-art technique.

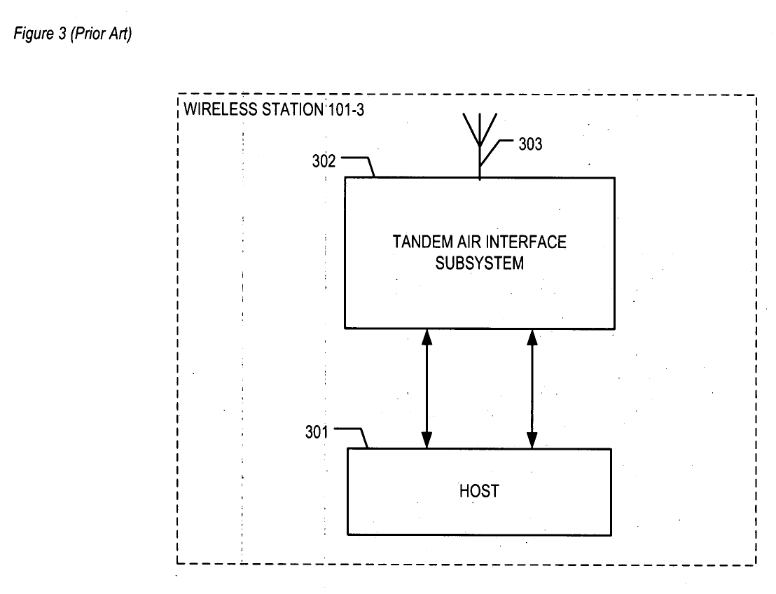

FIG. 4 depicts a block diagram of wireless station 101-3, in accordance with a third prior-art technique.

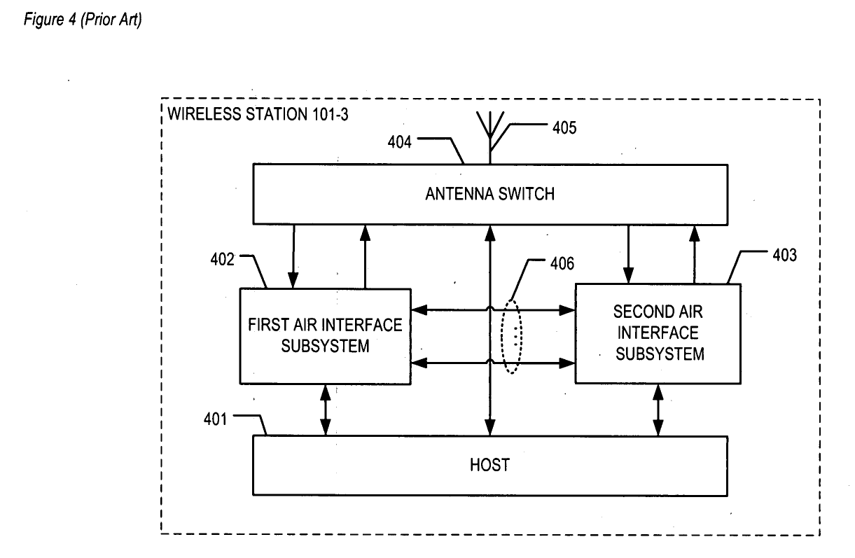

FIG. 5 depicts a block diagram of wireless station 500 in accordance with the first illustrative embodiment of the present invention.

FIG. 6 depicts a block diagram of host processor 501 in accordance with the illustrative embodiment of the present invention.

FIG. 7 depicts a block diagram of air-interface subsystem 502-1 in accordance with the first illustrative embodiment of the present invention.

FIG. 8 depicts a message flow diagram in accordance with the first illustrative embodiment of the present invention.

FIG. 9 depicts a block diagram of wireless station 900 in accordance with the second illustrative embodiment of the present invention.

FIG. 10 depicts a block diagram of air-interface subsystem 902-1 in accordance with the second illustrative embodiment of the present invention.

FIG. 11 depicts a block diagram of air-interface subsystem 902-2 in accordance with the second illustrative embodiment of the present invention.

FIG. 12 depicts a message flow diagram in accordance with the second illustrative embodiment of the present invention.

### DETAILED DESCRIPTION

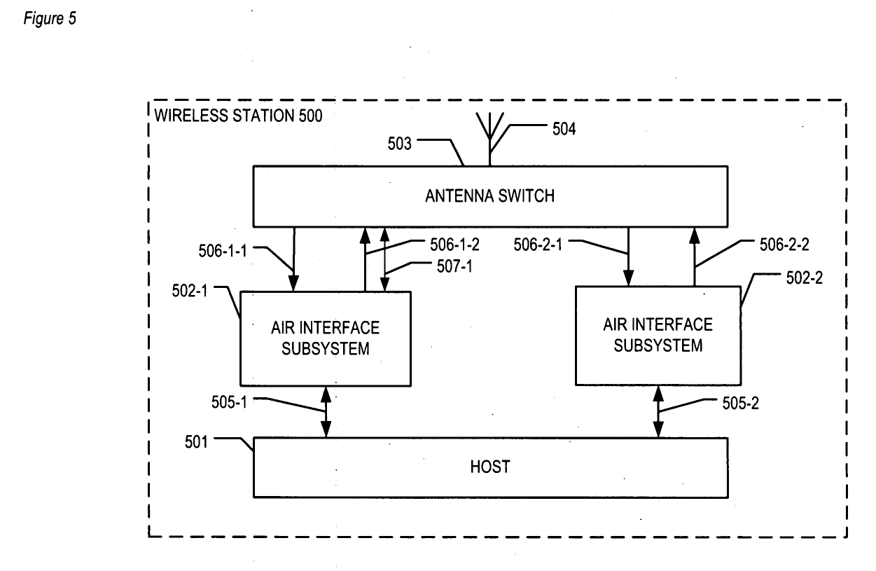

FIG. 5 depicts a block diagram of wireless station 500 in accordance with the first illustrative embodiment of the present invention. Wireless station 500 is a machine that supports two distinct wireless air-interface protocols for the purpose of transmitting and receiving voice, data, and/or video over a shared-communications channel. Wireless station 500 comprises: host 501, air-interface subsystem 502-1, air-interface subsystem 502-2, antenna switch 503, and antenna subsystem 504, interconnected as shown.

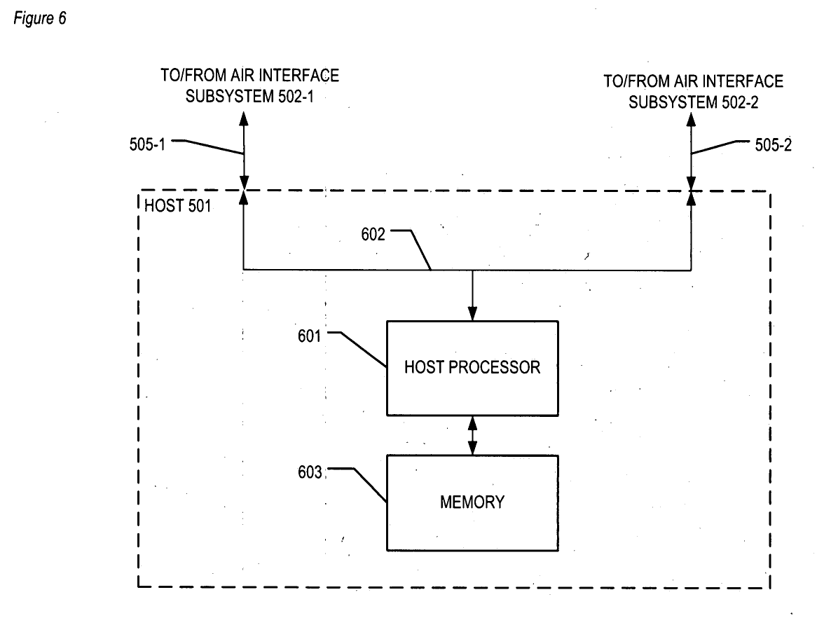

Host 501 is a machine that is capable of generating one or more data blocks to be transmitted over the wireless shared-communications channel by air-interface subsystems 502-1 and 502-2, in well-known fashion. Host 501 is also capable of processing one or more data blocks that it receives from the wireless shared-communications channel by air-interface subsystems 502-1 and 502-2, in well-known fashion. The salient details of host 501 are described below and with respect to FIG. 6.

Each of air-interface subsystems 502-1 and 502-2 comprises a radio that enables host 501 to communicate via the wireless shared-communications channel using a different air-interface protocol.

Air-interface subsystem 502-1 enables host 501 to communicate via the IEEE 802.11 air-interface protocol. Air-interface subsystem 502-1 communicates with host 501 via path 505-1.

Air-interface subsystem 502-2 enables host 501 to communicate via the Bluetooth air-interface protocol. Air-interface subsystem 502-2 communicates with host 501 via path 505-2.

Although the illustrative embodiment enables communication via the IEEE 802.11 and Bluetooth air-interface protocols, it will be clear to those skilled in the art, after reading this specification, how to make and use embodiments of the present invention that use other air-interface protocols.

Each of air-interface subsystems 502-1 and 502-2 is capable of receiving one or more data blocks from host 501 and transmitting, over the wireless shared-communications channel, one or more data frames that comprise the payload data received from host 501. Each of air-interface subsystems 502-1 and 502-2 is also capable of receiving one or more data frames from the wireless shared communications channel and sending to host 501 one or more data blocks comprising the payload data from the data frames. It will be clear to those skilled in the art, after reading this specification, how to make and use air-interface subsystems 502-1 and 502-2.

Antenna switch 503 enables air-interface subsystems 502-1 and 502-2 to share antenna subsystem 504. Antenna switch 503 provides signals to air-interface subsystem 502-1 via path 506-1-1 and to air-interface subsystem 502-2 via path 506-2-1. Antenna switch 503 accepts signals from air-interface subsystem 502-1 via path 506-1-2 and from air-interface subsystem 502-2 via path 506-2-2. It will be clear to those skilled in the art how to make and use antenna switch 503.

Antenna subsystem 504 couples the electrical signals of antenna switch 503 with the wireless shared-communications channel. It will be clear to those skilled in the art how to make and use antenna subsystem 504.

FIG. 6 depicts a block diagram of host processor 501 in accordance with the first illustrative embodiment of the present invention.

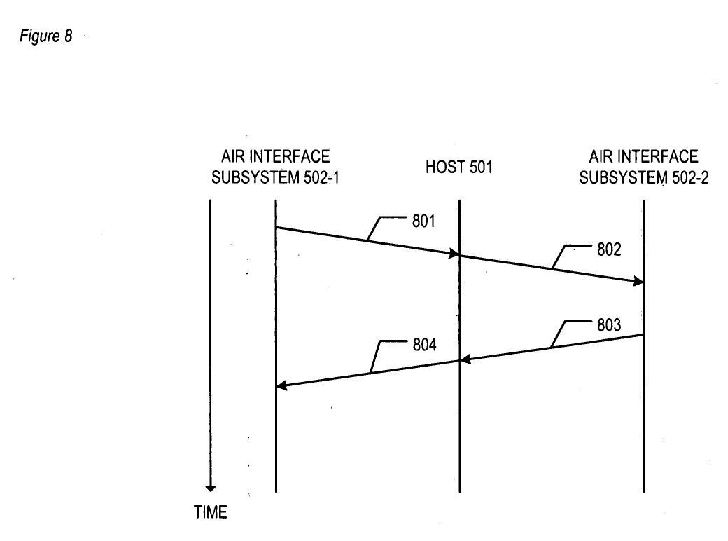

Host processor 601 is a general-purpose processor that is capable of performing the tasks described below and with respect to FIG. 8. In some embodiments of the present invention, host processor 601 executes universal serial bus (OSB) drivers that are used to interface with air-interface subsystems 502-1 and 502-2. It will be clear to those skilled in the art, after reading this specification, how to make and use host processor 601.

Wireline shared-communications channel 602 is an electrical connection that connects air-interface subsystems 502-1 and 502-2 with host processor 601. Wireline shared-communications channel 602 is compliant with the peripheral component interconnect (PCI) or PCI-X standard. In some alternative embodiments of the present invention, wireline shared-communications channel 602 is compliant with a different protocol. It will be clear to those skilled in the art how to make and use wireline shared-communications channel 602.

Memory 603 is capable of storing programs and data used by host processor 601. It will be clear to those skilled in the art how to make and use memory 603.

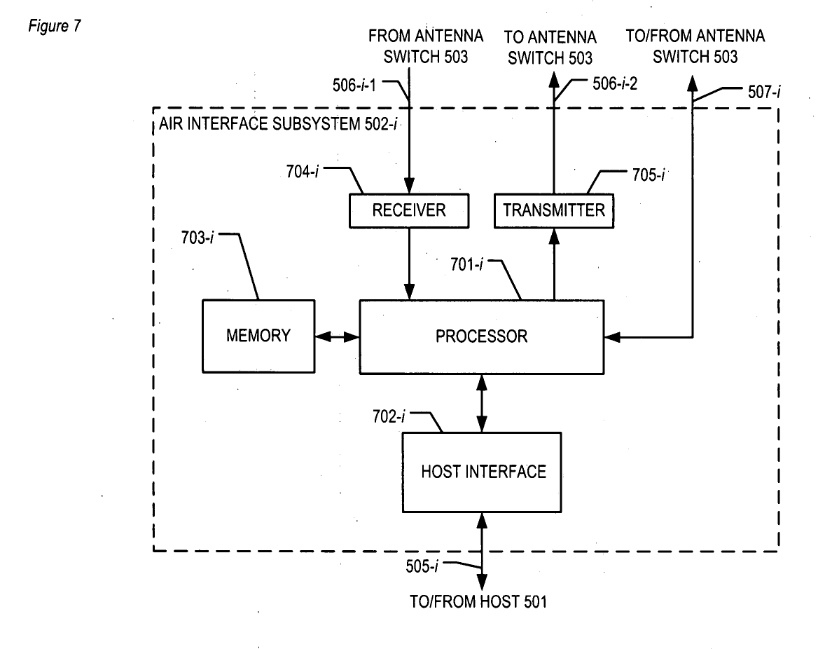

FIG. 7 depicts a block diagram of air-interface subsystem 502-i, for i=1 and 2, in accordance with the first illustrative embodiment of the present invention. Air-interface subsystem 502-i comprises processor 701-i, host interface 702-i, memory 703-i, receiver 704-i, and transmitter 705-i, interconnected as shown. Air-interface subsystem 502-1 also comprises lead 507-1 for controlling antenna switch 503.

Processor 701-i is a general-purpose processor that is capable of performing the tasks described below and with respect to FIG. 8. It will be clear to those skilled in the art, after reading this specification, how to make and use processor 701-i.

Host interface 702-i is a circuit that provides air-interface subsystem 502-i with an interface to host 501. It will be clear to those skilled in the art how to make and use host interface 702-i.

Memory 703-i is capable of storing programs and data used by processor 701-i. It will be clear to those skilled in the art how to make and use memory 703-i.

Receiver 704-i is a circuit that is capable of receiving frames from antenna switch 503, in well-known fashion, and of forwarding them to processor 701-i. It will be clear to those skilled in the art how to make and use receiver 704-i.

Transmitter 705-i is a circuit that is capable of receiving frames from processor 701-i, in well-known fashion, and of transmitting those frames to antenna switch 503. It will be clear to those skilled in the art how to make and use transmitter 705-i.

Air-interface subsystems 502-1 and 502-2 coordinate their use by exchanging coordination messages. For example, when air-interface subsystem 502-1 has to transmit immediately or at some point in the future, it notifies air-interface subsystem 502-2. Similarly, if air-interface subsystem 502-1 is neither transmitting nor receiving, it notifies air-interface subsystem 502-2 that an opportunity exists to use the wireless shared-communications channel.

The messages that coordinate air-interface subsystems 502-1 and 502-2 are exchanged through host 501.

At host 501, in some embodiments, software that is inserted at the operating system level or at the driver level (or both) recognizes incoming messages from one air-interface subsystem as being intended for the other air-interface subsystem. For example, a driver-level “shim” interface running on processor 601 can be used to intercept incoming messages from air-interface subsystem 502-2 and route them to air-interface subsystem 502-1. A “shim” is a software component inserted into the logical space between a higher-level program in host 501 and a program providing a communications service (e.g., a Bluetooth driver, an IEEE 802.11 driver, etc.). In this case, the shim intercepts the request on a first driver triggered by the incoming message from air-interface subsystem 502-2, translates the request, and routes the request to a second driver to transmit an outgoing message to air-interface subsystem 502-1. Higher-level entities running on processor 601 (e.g., application programs, etc.) need not be aware of the messages going back and forth between the air-interface subsystems. It will be clear to those skilled in the art how to insert software in host 501 to handle incoming messages from one device external to host 501 that are intended for another device external to host 501.

FIG. 8 depicts a message flow diagram in accordance with the first illustrative embodiment of the present invention. In FIG. 8, each of the two logical paths between (i) host 501 and air-interface subsystem 502-1 and (ii) host 501 and air-interface subsystem 502-2 coincide with a different physical path (i.e., 505-1 and 505-2).

With message 801, processor 701-1 of air-interface subsystem 502-1 transmits a first coordination message to host 501 via wireline shared-communications channel 602, which first message is addressed to air-interface subsystem 502-2.

Depending on the status of air-interface subsystem 502-1, the first message conveys:

1. a transmit inhibit signal, through which air-interface subsystem 502-1 commands air-interface subsystem 502-2 to inhibit transmitter 705-2; or

2. a polite request signal, which indicates to air-interface subsystem 502-2 that air-interface subsystem 502-1 has a data block to transmit, but does not necessarily have to send it right at that moment.

With message 802, host 501 forwards the first coordination message to air-interface subsystem 502-2 via wireline shared-communications channel 602.

With message 803, processor 702-2 generates a second coordination message delivery to processor 702-1, and, therefore, processor 702-2 transmits the message to host 501. The second coordination message can be generated in response to the receipt of the first coordination message or it can independent of the first coordination message.

Depending on the status of air-interface subsystem 502-2, the second message conveys:

1. a transmitting indication signal, which indicates if air-interface subsystem 502-2 is transmitting signals over the air;

2. a receiving indication signal, which indicates if air-interface subsystem 502-2 is receiving (or attempting to receive) signals from over the air; or

3. an idle indication signal, which indicates if air-interface subsystem 502-2 is neither in transmit mode nor in receive mode (but is still powered on).

With message 804, host 501 forwards the second message to air-interface subsystem 502-1 via wireline shared-communications channel 602. In this way, air-interface subsystems 502-1 and 502-2 can exchange the information to coordinate the use of the shared-communications channel.

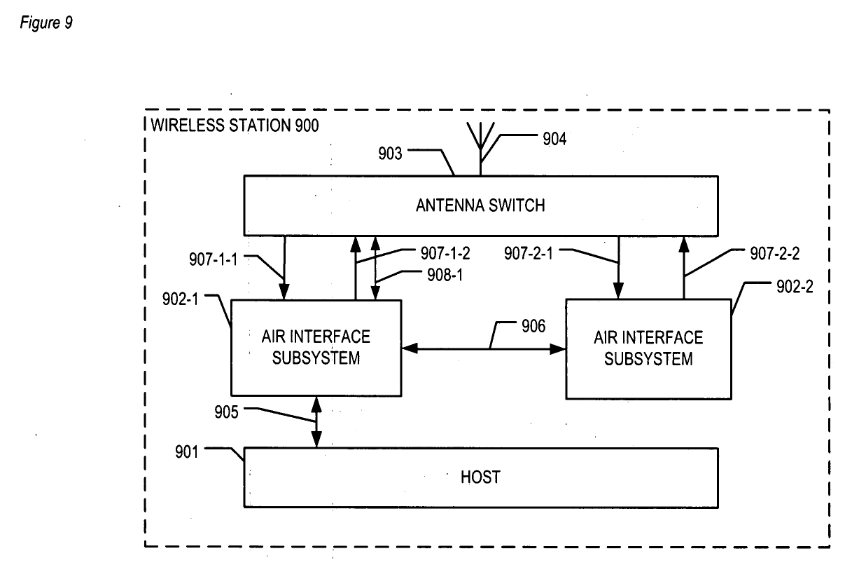

FIG. 9 depicts a block diagram of wireless station 900 in accordance with the second illustrative embodiment of the present invention. Wireless station 900 is a machine that supports two distinct wireless air-interface protocols for the purpose of transmitting and receiving data over the air via a shared-communications channel. Wireless station 900 comprises: host 901, air-interface subsystem 902-1, air-interface subsystem 902-2, antenna switch 903, and antenna subsystem 904, interconnected as shown.

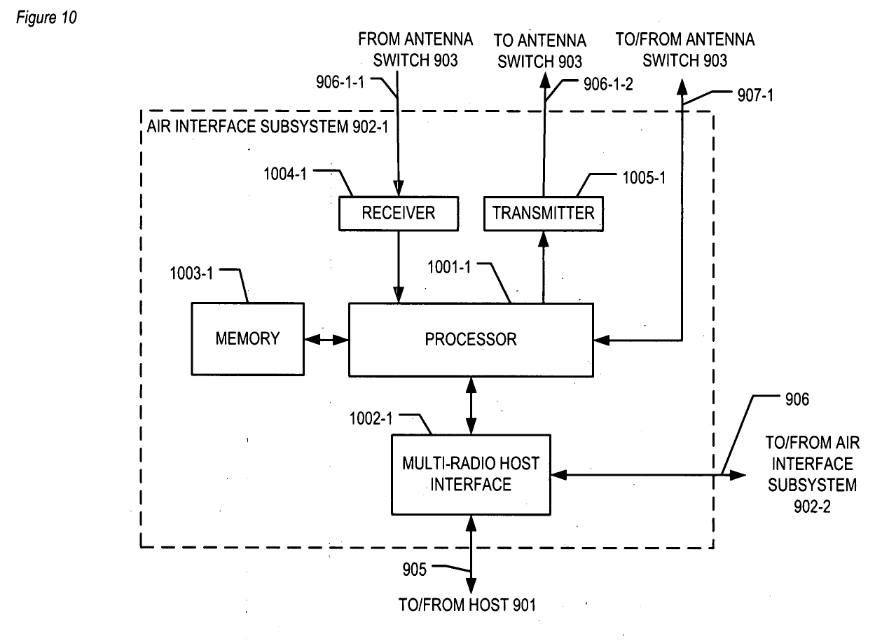

Host 901 is a machine that is capable of generating one or more data blocks to be transmitted over the wireless shared-communications channel by air-interface subsystems 902-1 and 902-2, in well-known fashion. Host 901 is also capable of processing one or more data blocks that it receives from the wireless shared-communications channel by air-interface subsystems 902-1 and 902-2, in well-known fashion. The salient details of host 901 are described below and with respect to FIG. 10.

Although the illustrative embodiment comprises two air-interface subsystems, it will be clear to those skilled in the art, after reading this specification, how to make and use embodiments of the present invention that comprises any number of air-interface subsystems.

Each of air-interface subsystems 902-1 and 902-2 comprises a radio that enables host 901 to communicate via the wireless shared-communications channel using a different air-interface protocol.

Air-interface subsystem 902-1 enables host 901 to communicate via the IEEE 802.11 air-interface protocol. Air-interface subsystem 902-1 communicates with host 901 via path 905-1.

Air-interface subsystem 902-2 enables host 901 to communicate via the Bluetooth air-interface protocol. Air-interface subsystem 902-2 communicates with host 901 via path 905-2.

Although the illustrative embodiment enables communication via the IEEE 802.11 and Bluetooth air-interface protocols, it will be clear to those skilled in the art, after reading this specification, how to make and use embodiments of the present invention that use other air-interface protocols.

Each of air-interface subsystems 902-1 and 902-2 is capable of receiving one or more data blocks from host 901 and transmitting, over the wireless shared-communications channel, one or more data frames that comprises the payload data received from host 901. Each of air-interface subsystems 902-1 and 902-2 is also capable of receiving one or more data frames from the wireless shared communications channel and sending to host 901 one or more data blocks comprising the payload data from the data frames. It will be clear to those skilled in the art, after reading this specification, how to make and use air-interface subsystems 902-1 and 902-2.

Antenna switch 903 enables air-interface subsystems 902-1 and 902-2 to share antenna subsystem 904. Antenna switch 903 provides signals to air-interface subsystem 902-1 via path 906-1-1 and to air-interface subsystem 902-2 via path 906-2-1. Antenna switch 903 accepts signals from air-interface subsystem 902-1 via path 906-1-2 and from air-interface subsystem 902-2 via path 906-2-2. It will be clear to those skilled in the art how to make and use antenna switch 903.

Antenna subsystem 904 couples the electrical signals of antenna switch 903 with the wireless shared-communications channel. It will be clear to those skilled in the art how to make and use antenna subsystem 904.

FIG. 10 depicts a block diagram of air-interface subsystem 902-1 in accordance with the second illustrative embodiment of the present invention. Air-interface subsystem 902-1 comprises processor 1001-1, multi-radio host interface 1002-1, memory 1003-1, receiver 1004-1, and transmitter 1005-1, interconnected as shown.

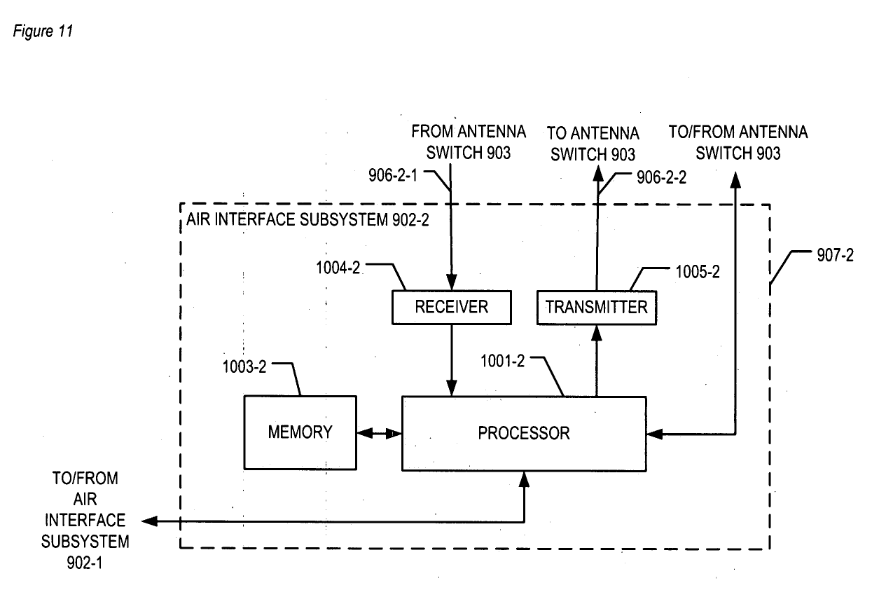

Processor 1001-1 is a general-purpose processor that is capable of performing the tasks described below and with respect to FIG. 11. It will be clear to those skilled in the art, after reading this specification, how to make and use processor 1001-1.

Multi-radio host interface 1002-1 is a circuit that provides air-interface subsystem 902-1 with a physical and logical interface to host 901. Furthermore, multi-radio host interface 1002-1 provides a physical interface to air-interface subsystem 902-2 and acts as a logical conduit for messages exchanged between host 901 and air-interface subsystem 902-2. In other words, multi-radio host interface 1002-1 does not switch messages between processor 1001-1 and air-interface subsystem 902-2. Instead, messages between processor 1001-1 and air-interface subsystem 902-2 are physically routed by multi-radio host interface 1002-1 to host 901 which re-routes them back to multi-radio host interface 1002-1 for forwarding to their final destination. It will be clear to those skilled in the art, after reading this specification, how to make and use multi-radio host interface 1002-1. Furthermore, it will be clear to those skilled in the art, after reading this specification, how to make and use host 901 to re-route messages from one air-interface subsystem to another air-interface subsystem.

Memory 1003-1 is capable of storing programs and data used by processor 1001-1. It will be clear to those skilled in the art how to make and use memory 1003-1.

Receiver 1004-1 is a circuit that is capable of receiving frames from antenna switch 603, in well-known fashion and of forwarding them to processor 1001-1. It will be clear to those skilled in the art how to make and use receiver 1004-1.

Transmitter 1005-1 is a circuit that is capable of receiving frames from processor 1001-1, in well-known fashion, and of transmitting those frames to antenna switch 603. It will be clear to those skilled in the art how to make and use transmitter 1005-1.

FIG. 11 depicts a block diagram of air-interface subsystem 902-2, in accordance with the second illustrative embodiment of the present invention. Air-interface subsystem 902-2 comprises processor 1001-2, multi-radio host interface 1002-2, memory 1003-2, receiver 1004-2, and transmitter 1005-2, interconnected as shown.

Processor 1001-2 is a general-purpose processor that is capable of performing the tasks described below and with respect to FIG. 11. It will be clear to those skilled in the art, after reading this specification, how to make and use processor 1001-2.

Memory 1003-2 is capable of storing programs and data used by processor 1001-2. It will be clear to those skilled in the art how to make and use memory 1003-2.

Receiver 1004-2 is a circuit that is capable of receiving frames from antenna switch 603, in well-known fashion, and of forwarding them to processor 1001-2. It will be clear to those skilled in the art how to make and use receiver 1004-2.

Transmitter 1005-2 is a circuit that is capable of receiving frames from processor 1001-1, in well-known fashion, and of transmitting those frames to antenna switch 603. It will be clear to those skilled in the art how to make and use transmitter 1005-2.

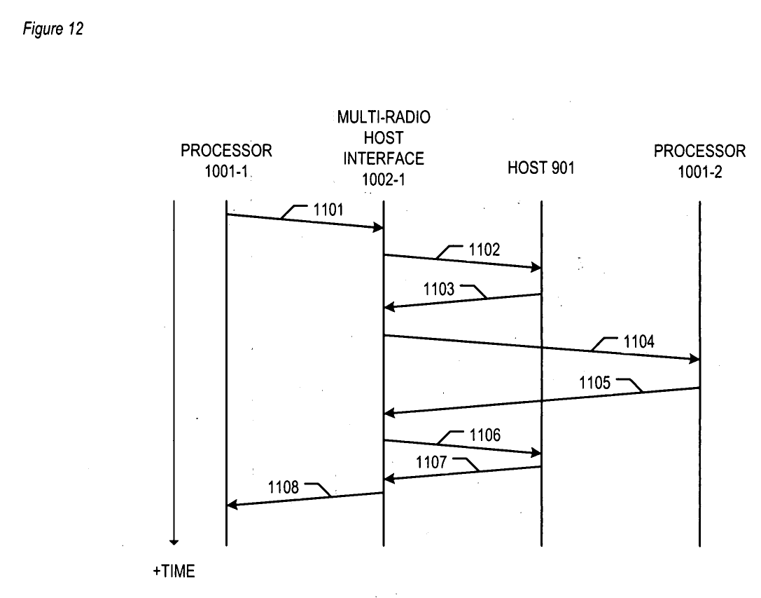

FIG. 12 depicts a message flow diagram in accordance with the second illustrative embodiment of the present invention. In the second described configuration, both of the logical paths between i) host 901 and air-interface subsystem 902-1 and ii) host 901 and air-interface subsystem 902-2 share a single physical path (i.e., between host 901 and air-interface subsystem 902-1).

Air-interface subsystems 902-1 and 902-2 coordinate with each other in order to coexist on the same shared-communications channel. The coordination signaling that is exchanged between air-interface subsystems 902-1 and 902-2 comprise transmit requests and transmit opportunity indications. For example, when air-interface subsystem 902-1 has to transmit immediately or at some point in the future, it has to be able to notify air-interface subsystem 902-2. As another example, if air-interface subsystem 902-1 is neither transmitting nor receiving, it can notify air-interface subsystem 902-2 that an opportunity exists to use the wireless shared-communications channel.

With message 1101, processor 1001-1 of air-interface subsystem 902-1 generates a first coordination message for delivery to processor 1001-2, and, therefore, processor 1001-1 transmits the message to multi-radio host interface 1002-1.

Depending on the status of air-interface subsystem 902-1, the first coordination message conveys:

1. a transmit inhibit signal, through which air-interface subsystem 902-1 commands air-interface subsystem 902-2 to inhibit transmitter 1005-2; or

2. a polite request signal, which indicates to air-interface subsystem 902-2 that air-interface subsystem 902-1 has a data block to transmit, but does not necessarily have to send it right at that moment.

With message 1102, multi-radio host interface 1002-1 forwards the first coordination message to host 901 via wireline shared-communications channel 905.

With message 1103, host 901 re-routes the first coordination message back to multi-radio host interface 1002-1 for delivery to processor 1001-2 of air-interface subsystem 902-1.

With message 1104, multi-radio host interface 1002-1 forwards the first coordination message to processor 1001-2, and processor 1001-2 processes the first coordination message accordingly.

With message 1105, processor 1001-2 generates a second coordination message delivery to processor 1001-2, and, therefore, processor 1001-2 transmits the message to multi-radio host interface 1002-1. The second coordination message can be generated in response to the receipt of the first coordination message or it can independent of the first coordination message.

Depending on the status of air-interface subsystem 502-2, the second message conveys:

1. a transmitting indication signal, which indicates if air-interface subsystem 902-2 is transmitting signals over the air;

2. a receiving indication signal, which indicates if air-interface subsystem 902-2 is receiving (or attempting to receive) signals from over the air; or

3. an idle indication signal, which indicates if air-interface subsystem 902-2 is neither in transmit mode nor in receive mode (but is still powered on).

With message 1106, multi-radio host interface 1002-1 forwards the second coordination message to host 901.

With message 1107, host 901 re-routes the second coordination message to multi-radio host interface 1002-1 for delivery to processor 1001-1.

With message 1108, multi-radio host interface 1002-1 forwards the second coordination message to processor 1001-1, and processor 1001-1 processes the second coordination message accordingly.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method comprising:
receiving a first message at a host processor from a first processor via a wireline shared-communications channel, wherein said first processor performs channel-access control for a first radio, and wherein said first radio communicates via a wireless shared-communications channel on behalf of said host processor;
determining with said host processor that said first message is directed to a second processor, wherein said second processor performs channel-access control for a second radio, and wherein said second radio communicates via said wireless shared-communications channel on behalf of said host processor; and
forwarding said first message from said host processor to said second processor via said wireline shared-communications channel.

2. The method of claim 1 wherein said first radio is Bluetooth compliant and said second radio is IEEE 802.11 compliant.

3. The method of claim 1 wherein said first message conveys one of a transmit inhibit signal and a polite request signal.

4. The method of claim 1 further comprising:
receiving a second message at said host processor from said second processor;
determining with said host processor that said second message is directed to said first processor; and
forwarding said second message from said host processor to said first processor.

5. The method of claim 4 wherein said second message conveys one of a transmitting indication signal, a receiving indication signal, and an idle indication signal.

6. The method of claim 1 wherein said host processor determines by using software that said first message is directed to said second processor.

7. An apparatus comprising:
a first processor for transmitting a first message on a wireline shared-communications channel, wherein said first processor performs channel-access control for a first radio, and wherein said first radio communicates via a wireless shared-communications channel on behalf of said host processor;
a host processor for determining that said first message is directed to a second processor, and for forwarding said first message to said second processor via said wireline shared-communications channel; and
a second processor for receiving said first message from said wireline shared-communications channel, wherein said second processor performs channel-access control for a second radio, and wherein said second radio communicates via said wireless shared-communications channel on behalf of said host processor.

8. The apparatus of claim 7 wherein said first radio is Bluetooth compliant and said second radio is IEEE 802.11 compliant.

9. The apparatus of claim 7 wherein said first message conveys one of a transmit inhibit signal and a polite request signal.

10. The apparatus of claim 7:
wherein said second processor is also for transmitting a second message on said wireline shared-communications channel;
wherein said host processor is also for determining that said second message is directed to said second processor and for forwarding said second message to said first processor via said wireline shared-communications channel; and
wherein said first processor is also for receiving said second message from said wireline shared-communications channel.

11. The apparatus of claim 10 wherein said second message conveys one of a transmitting indication signal, a receiving indication signal, and an idle indication signal.

12. The apparatus of claim 7 wherein said host processor determines by using software that said first message is directed to said second processor.

13. An apparatus comprising:
(1) a wireline shared-communications channel for:
(a) transmitting a first message from a first processor to a host processor, wherein said first processor performs channel-access control for a first radio, and wherein said first radio communicates via a wireless shared-communications channel on behalf of said host processor; and
(b) transmitting said first message from said host processor to said second processor, wherein said second processor performs channel-access control for a second radio, and wherein said second radio communicates via said wireless shared-communications channel on behalf of said host processor; and
(2) said host processor for determining that said first message is directed to a second processor, and for forwarding said first message to said second processor via said wireline shared-communications channel.

14. The apparatus of claim 13 wherein said first radio is Bluetooth compliant and said second radio is IEEE 802.11 compliant.

15. The apparatus of claim 13 wherein said first message conveys one of a transmit inhibit signal and a polite request signal.

16. The apparatus of claim 13:
wherein said second processor is also for transmitting a second message on said wireline shared-communications channel;
wherein said host processor is also for determining that said second message is directed to said second processor and for forwarding said second message to said first processor via said wireline shared-communications channel; and
wherein said first processor is also for receiving said second message from said wireline shared-communications channel.

17. The apparatus of claim 16 wherein said second message conveys one of a transmitting indication signal, a receiving indication signal, and an idle indication signal.

18. The apparatus of claim 13 wherein said host processor determines by using software that said first message is directed to said second processor.

19. The apparatus of claim 13 wherein said wireline shared-communications channel accepts Mini-PCI and PCI printed circuit cards.

20. The apparatus of claim 13 wherein said host processor executes USB drivers.
